(19) United States
(12) Patent Application Publication
(10) Pub. No.: US 2015/0247082 A1
(43) Pub. Date: Sep. 3, 2015

(54) ADDITIVES FOR USE WITH DRILLING FLUIDS AND RELATED COMPOSITIONS AND METHODS

(71) Applicant: CESI Chemical, Inc., Houston, TX (US)

(72) Inventor: Anthony B. Rea, Kingwood, TX (US)

(73) Assignee: CESI Chemical, Inc., Houston, TX (US)

(21) Appl. No.: 14/561,428

(22) Filed: Dec. 5, 2014

Related U.S. Application Data
(60) Provisional application No. 62/051,747, filed on Sep. 17, 2014.
(60) Provisional application No. 61/946,046, filed on Feb. 28, 2014.

(51) Int. Cl. C09K 8/36

(52) U.S. Cl. CPC C09K 8/36

(57) ABSTRACT

Compositions for use with drilling fluids (e.g., drilling muds) and other related fluids and related methods are generally provided. In some embodiments, a composition is provided comprises a cationic inhibitor and/or a cationic stabilizer and an emulsion or a microemulsion. In some embodiments, a method for treating an oil and/or gas well is provided comprising providing a composition comprising a drilling fluid, a cationic inhibitor and/or a cationic stabilizer and an emulsion or microemulsion to a wellbore of the oil and/or gas well.

### RELATED APPLICATIONS

The present application claims priority under 35 U.S.C. §119(e) to U.S. Provisional Application Ser. No. 61/913,028, filed Dec. 6, 2013, entitled “ADDITIVES FOR USE WITH DRILLING FLUIDS AND RELATED COMPOSITIONS AND METHODS”; U.S. Provisional Application Ser. No. 61/946,046, filed Feb. 28, 2014, entitled “ADDITIVES FOR USE WITH DRILLING FLUIDS AND RELATED COMPOSITIONS AND METHODS”; and U.S. Provisional Application Ser. No. 62/051,747, filed Sep. 17, 2014, entitled “ADDITIVES FOR USE WITH DRILLING FLUIDS AND RELATED COMPOSITIONS AND METHODS”, each of which is incorporated herein by reference.

### FIELD OF THE INVENTION

Compositions for use with drilling fluids (e.g., drilling muds) and other related fluids and related methods are generally provided.

### BACKGROUND

Generally, when drilling an oil and/or gas well, a drilling fluid (e.g., drilling muds such as water-based muds, including fresh water, brackish and salt muds, etc.) is circulated. The drilling fluid, for example, may provide back pressure on penetrated formations (e.g., to prevent blow-out) and/or carry the cuttings from the drill bit to the surface of the earth.

As will be known to those of ordinary skill in the art, standard drilling procedures face challenges that can compromise the structural integrity of the well. For example, the challenges can include stress cage aggravation when countless capillaries imbibe (absorb) fluids via natural vacuum pressure of the well. The impact of this imbibition is increased pore pressure, which can drive destabilization of the stress cage.

Accordingly, improved compositions and methods are needed.

### SUMMARY OF THE INVENTION

Compositions for use with drilling fluids (e.g., drilling muds) and other related fluids and related methods are generally provided.

In some embodiments, compositions for the treatment of an oil and/or gas well are provided. In some embodiments, a composition for treatment of an oil and/or gas well comprises a cationic inhibitor and/or a cationic stabilizer and an emulsion or a microemulsion.

In some embodiments, methods for treating an oil and/or gas well are provided. In some embodiments, a method for treating an oil and/or gas well comprises providing a composition comprising a drilling fluid, a cationic inhibitor and/or a cationic stabilizer, and an emulsion or microemulsion to a wellbore of the oil and/or gas well.

Other advantages and novel features of the present invention will become apparent from the following detailed description of various non-limiting embodiments of the invention when considered in conjunction with the accompanying figures. In cases where the present specification and a document Incorporated by reference include conflicting and/or inconsistent disclosure, the present specification shall control. If two or more documents incorporated by reference include conflicting and/or inconsistent disclosure with respect to each other, then the document having the later effective date shall control.

### DETAILED DESCRIPTION

Compositions for use with drilling fluids (e.g., drilling muds) and other related fluids and related methods are generally provided. In some embodiments, compositions are provided comprises a cationic inhibitor and/or a cationic stabilizer and an emulsion or a microemulsion. In some embodiments, methods for treating an oil and/or gas well are provided comprising providing a composition comprising a drilling fluid, a cationic inhibitor and/or a cationic stabilizer and an emulsion or microemulsion to a wellbore of the oil and/or gas well.

In some embodiments, the compositions provided described provide many advantages over current technologies. For example, in some embodiments, the compositions described herein mitigate near-bore hole stress cage aggravation, due to clay swelling, for example, by delivering cationic inhibitors and/or stabilizers through the imbibition process into the primary permeability. In this way, imbibition may be converted from a significant liability to a proactive tool that stabilizes the near-bore hole stress cage. In addition, this process may reduce pore pressures, which can increase stabilization of the stress cage, and may optimize the permeability to hydrocarbons and priming the well for maximum results. Further, imbibition and phase trapping may shut down or limit production from primary permeability. In some embodiments, the compositions provided herein comprise micelles which are introduced into the reservoir in the 10-30 nano-meter size range, which can allow them to use naturally occurring imbibition to penetrate even low-perm environments and diminish the capillary pressures (e.g., by 60% or more). In addition, the compositions provided herein may improve the contact angle and wettability on the surface of the treated formations. Advantages to this include increasing the permeability of hydrocarbons as well as streamlining cleanup. Reduced interfacial tensions between the solid, liquid, and gas phases can allow the hydrocarbons to flow more easily, optimizing production.

Furthermore, in addition, when drilling oil and/or gas wells in which shale and/or clay (and/or other water-absorbing materials) are present, a problem often encountered is the loss of fluid from the drilling fluid into the shale and/or clay (or other water-absorbing material). In some embodiments, the compositions provided herein may reduce and/or prevent the loss of fluid from the drilling fluid into the shale and/or clay (and/or other water-absorbing materials). These and other advantages are described in more detail herein.

In some embodiments, a composition is provided comprising an emulsion or microemulsion. In some embodiments, the composition further comprises a cationic inhibitor and/or cationic stabilizer (e.g.,. a cationic shale and/or clay inhibitor and/or a cationic shale and/or clay stabilizer). The cationic inhibitor and/or cationic stabilizer may or may not be contained within the emulsion or microemulsion. For example, in some embodiments, the emulsion or microemulsion comprises the cationic inhibitor and/or cationic stabilizer. In other embodiments, the composition may comprise the emulsion or microemulsion which is formed prior to the addition of the cationic inhibitor and/or cationic stabilizer, wherein the cationic inhibitor and/or cationic stabilizer is added as a separate component to the drilling fluid.

The compositions described herein may be utilized in oil and/or gas well drilling. In some embodiments, the composition is added to a drilling fluid. Non-limiting examples of drilling fluids include water-based systems, oil-based systems, and low viscosity oils (e.g., diesel, crude oil, etc.). In some embodiments, the drilling fluid is a water-based system. In some embodiments, the oil and/or gas well comprises shale gas plays, coalbed methane, carbonates, and/or tight sands. In a particular embodiment, the oil and/or gas well comprises coalbed methane.

The terms emulsion and microemulsion should be understood to include emulsions or microemulsions that have a water continuous phase, or that have an oil continuous phase, or microemulsions that are bicontinuous. As used herein, the term “emulsion” is given its ordinary meaning in the art and refers to dispersions of one immiscible liquid in another, in the form of droplets, with diameters approximately in the range of 100-1,000 nanometers. Emulsions may be thermodynamically unstable and/or require high shear forces to induce their formation.

As used herein, the term “microemulsion” is given its ordinary meaning in the art and refers to dispersions of one immiscible liquid in another, in the form of droplets, with diameters approximately in the range of about 10-100 nanometers. In some embodiments, the average diameter is between about 10 and about 30 nanometers. Microemulsions are clear or transparent because they contain particles smaller than the wavelength of visible light. In addition, microemulsions are thermodynamically stable and form spontaneously, and thus, differ markedly from thermodynamically unstable emulsions, which generally depend upon intense mixing energy for their formation. The microemulsion may be single phased. Microemulsions may be characterized by a variety of advantageous properties including, by not limited to, (i) clarity, (ii) very small particle size, (iii) ultra-low interfacial tensions, (iv) the ability to combine properties of water and oil in a single homogeneous fluid, (v) shelf stability, and (vi) ease of preparation. It should be understood, that while much of the description herein focuses on microemulsions, this is by no means limiting, and emulsions may be employed where appropriate.

In some embodiments, a microemulsion comprises an aqueous component (e.g., water), an organic component (e.g., an organic solvent), and a surfactant. In some embodiments, the microemulsion may further comprise addition components, for example, a freezing point depression agent. Details of each of the components of the microemulsions are described in detail herein.

Those of ordinary skill in the art will be able to select a suitable organic component to use with the emulsions described herein. In some embodiments, the organic component comprises a terpene (e.g., limonene). Other non-limiting examples of organic components include hydrocarbons, oils (e.g., mineral oils), diesel, esters, aromatic and non-aromatic organic molecules (e.g., xylene), and fatty acids. The organic component may be present in the microemulsion in any suitable amount. In some embodiments the organic component is present in an amount between about between about 2 wt % and about 60 wt %, or between about 5 wt % and about 40 wt %, or between about 5 wt % and about 30 wt %, versus the total emulsion or microemulsion composition.

The aqueous component (e.g., water) to organic component ratio in a microemulsion may be varied. In some embodiments, the ratio of water to organic component is between about 3:1 and about 1:2, or between about 2:1 and about 1:1.5. In other embodiments, the ratio of water to organic component is between about 10:1 and about 3:1, or between about 6:1 and about 5:1.

In some embodiments, the microemulsion comprises a surfactant. The microemulsion may comprise a single surfactant or a combination of two or more surfactants. For example, in some embodiments, the surfactant comprises a first type of surfactant and a second type of surfactant. The term “surfactant,” as used herein, is given its ordinary meaning in the art and refers to compounds having an amphiphilic structure which gives them a specific affinity for oil/water-type and water/oil-type interfaces which helps the compounds to reduce the free energy of these interfaces and to stabilize the dispersed phase of a microemulsion. The term surfactant encompasses cationic surfactants, anionic surfactants, amphoteric surfactants, nonionic surfactants, zwitterionic surfactants, and mixtures thereof. In some embodiments, the surfactant is a nonionic surfactant. Nonionic surfactants generally do not contain any charges. Amphoteric surfactants generally have both positive and negative charges, however, the net charge of the surfactant can be positive, negative, or neutral, depending on the pH of the solution. Anionic surfactants generally possess a net negative charge. Cationic surfactants generally possess a net positive charge. Suitable surfactants for use with the microemulsion compositions and methods described herein will be known in the art.

Non-limiting examples of surfactants include polyoxyethylene sorbitan monopalmitate, polyoxyethylene sorbitan monostearate, polyoxyethylene sorbitan monooleate, linear alcohol alcoxylates, alkyl ether sulfates, dodecylbenzene sulfonic acid (DDBSA), linear nonyl-phenols, dioxane, ethylene oxide, ethoxylated castor oil dipalmitoylphosphatidylcholine (DPPC), sodium 4-(1′ heptylnonyl)benzenesulfonate (SHPS or SHBS), polyoxyethylene(8.6) nonyl phenyl ether, aerosol O.T. (sodium bis-2-ethylhexylsulphosuccinate), tetraethyleneglycoldodecylether, sodium octlylbenzenesulfonate, sodium ether surfactant, ethoxylated sulfonates (e.g., alkyl propoxy-ethoxysulfonate), alkyl propoxy-ethoxysulfate, alkylarylpropoxy-ethoxysulfonate, substituted benzene sulfonates, sorbitan monopalmitate, sorbitan monostearate, and sorbitan monooleate.

Those of ordinary skill in the art will be aware of methods and techniques for selecting surfactants for use in the microemulsions described herein. In some cases, the surfactant(s) are matched to and/or optimized for the particular oil or solvent in use. In some embodiments, the surfactant(s) are selected by mapping the phase behavior of the microemulsion and choosing the surfactant(s) that gives the desired range of stability. In some cases, the stability of the microemulsion over a wide range of temperatures is targeting as the microemulsion may be subject to a wide range of temperatures due to the environmental conditions present at the subterranean formation.

The surfactant may be present in the microemulsion in any suitable amount. In some embodiments, the surfactant (or total amount of surfactants) is present in an amount between about 10 wt % and about 70 wt %, or between about 15 wt % and about 55 wt % versus the total emulsion or microemulsion composition, or between about 20 wt % and about 50 wt %, versus the total emulsion or microemulsion composition. In some embodiments, the surfactant is as described in U.S. Pat. No. 7,380,606, herein incorporated by reference.

In some embodiments, the microemulsion comprises a freezing point depression agent. The microemulsion may comprise a single freezing point depression agent or a combination of two or more freezing point depression agent. For example, in some embodiments, the freezing point depression agent comprises a first type of freezing point depression agent and a second type of freezing point depression agent. The term “freezing point depression agent” is given its ordinary meaning in the art and refers to a compound which is added to a solution to reduce the freezing point of the solution. That is, a solution comprising the freezing point depression agent has a lower freezing point as compared to an essentially identical solution not comprising the freezing point depression agent. Those of ordinary skill in the art will be aware of suitable freezing point depression agents for use in the microemulsions described herein. Non-limiting examples of freezing point depression agents include primary, secondary, and tertiary alcohols with between 1 and 20 carbon atoms. In some embodiments, the alcohol comprises at least 2 carbon atoms, alkylene glycols including polyalkylene glycols, and salts. Non limiting examples of alcohols include methanol, ethanol, i-propanol, n-propanol, t-butanol, n-butanol, n-pentanol, n-hexanol, and 2-ethyl hexanol. In some embodiments, the freezing point depression agent is not methanol (e.g., due to toxicity). Non-limiting examples of alkylene glycols include ethylene glycol (EG), polyethylene glycol (PEG), propylene glycol (PG), and triethylene glycol (TEG). In some embodiments, the freezing point depression agent is not ethylene oxide (e.g., due to toxicity). Non limiting examples of salts include salts comprising K, Na, Br, Cr, Cr, Cs, or Bi, for example, halides of these metals, including NaCl, KCl, CaCl₂, and MgCl. In some embodiments, the freezing point depression agent comprises an alcohol and an alkylene glycol. Another non-limiting example of a freezing point depression agent is a combination of choline chloride and urea.

The freezing point depression agent may be present in the microemulsion in any suitable amount. In some embodiments, the freezing point depression agent is present in an amount between about 1 wt % and about 40 wt %, or between about 3 wt % and about 20 wt %, or between about 8 wt % and about 16 wt %, versus the total microemulsion composition.

In some embodiments, the components of the microemulsion and/or the amounts of the components may be selected so that the microemulsion is stable over a wide-range of temperatures. For example, the microemulsion may exhibit stability between about −40° F. and about 300° F., or between about −40° F. and about 150° F. Those of ordinary skill in the art will be aware of methods and techniques for determining the range of stability of the microemulsion. For example, the lower boundary may be determined by the freezing point and the upper boundary may be determined by the cloud point and/or using spectroscopy methods. Stability over a wide range of temperatures may be important in embodiments where the microemulsions are being employed in applications comprising environments wherein the temperature may vary significantly, or may have extreme highs (e.g., desert) or lows (e.g., artic).

The microemulsions described herein may be formed using methods known to those of ordinary skill in the art. In some embodiments, the aqueous and non-aqueous phases may be combined (e.g., the water and the organic component), followed by addition of a surfactant(s) and optionally other components (e.g., freezing point depression agent(s)) and agitation. The strength, type, and length of the agitation may be varied as known in the art depending on various factors including the components of the microemulsion, the quantity of the microemulsion, and the resulting type of microemulsion formed. For example, for small samples, a few seconds of gentle mixing can yield a microemulsion, whereas for larger samples, longer agitation times and/or stronger agitation may be required. Agitation may be provided by any suitable source, for example, a vortex mixer, a stirrer (e.g., magnetic stirrer), etc.

In some embodiments, the emulsion or microemulsion is as described in U.S. Pat. No. 7,380,606, herein incorporated by reference.

The emulsion and/or microemulsion may be incorporated into a drilling fluid in any suitable amount. In some embodiments, the emulsion or microemulsion is incorporated into the drilling fluid prior to and/or during injection into the wellbore. In some embodiments, a composition is provided comprising a microemulsion and the drilling fluid (e.g., drilling mud). The microemulsion may be present in an amount between 0.001 wt % and 1 wt %, or between about 0.001 wt % and about 0.05 wt %, or between about 0.01 wt % and about 0.1 wt % versus the drilling fluid. Generally, incorporation of the microemulsion into a drilling fluid does not result in the breakdown of the microemulsion. The composition may be utilized in methods involving drilling an oil and/or gas well.

In some embodiments, the composition comprises an inhibitor and/or stabilizer. The terms inhibitor and/or stabilizer are given their ordinary meaning in the art and generally refer to materials that prevent and/or retard a fluid (e.g., drilling fluid) from hydrating, swelling, and/or disintegrating the materials in the formation that are being drilled through, for example, clay and/or shale. In some embodiments, the inhibitor and/or stabilizer is a cationic inhibitor and/or stabilizer. In addition, the inhibitor and/or stabilizer may be targeted for use as a shale and/or clay inhibitor and/or stabilizer (e.g., a cationic shale and/or clay inhibitor and/or a cationic shale and/or clay stabilizer). The inhibitor and/or stabilizer may be contained within the microemulsion, or may be a separate component added to the composition (e.g., to a drilling fluid, separate from the emulsion or the microemulsion). In some embodiments, the inhibitor and/or stabilizer is not contained in the emulsion or the microemulsion.

Inhibitors and/or stabilizer will be known to those of ordinary skill in the art. Many inhibitors and/or stabilizers are commercially available. Non-limiting examples of inhibitors and/or stabilizers include polymer lattices; partially hydrolyzed polyvinylacetate; polyacrylamide; copolymers of anionic and cationic monomers (e.g., acrylic acid (AA), methacrylic acid, 2-acrylamido-2-methyl-1-propane sulfonic acid, dimethyl diallyl ammonium chloride); partially hydrolyzed acrylamide-acrylate copolymer, potassium chloride, and polyanionic cellulose (PAC); aluminum/guanidine complexes with cationic starches and polyalkylene glycols; hydroxyaldehydes or hydroxyketones; polyols and alkaline salt; tetramethylammonium chloride and methyl chloride quaternary salt of polyethyleneimine; pyruvic aldehyde and a triamine; quaternary ammonium compounds; in situ crosslinking of epoxide resins; oligomer (methyl quaternary amine containing 3-6 moles of epihalohydrin); quaternary ammonium carboxylates; quaternized trihydroxyalkyl amine; polyvinyl alcohol, potassium silicate, and potassium carbonate; copolymer of styrene and substituted maleic anhydride (MA); potassium salt of carboxymethyl cellulose, and salts (e.g., KCl); (e.g., see Petroleum Engineer's Guide to Oil Field Chemicals and Fluids, Chapter 3, 2012, Elsevier, pages 125-148, herein incorporated by reference).

In some embodiments, the cationic inhibitor and/or stabilizer (e.g., clay and/or shale cationic inhibitor and/or stabilizer) is a quaternary ammonium compound. In some embodiments, the quaternary ammonium compound has the structure (NR₄)⁺X⁻, wherein each R is the same or different and is optionally substituted alkyl, optionally substituted heteroalkyl, optionally substituted aryl, or optionally substituted heteroaryl, and X is a counter ion. In some embodiments, the quaternary ammonium compound is a polymer comprising a plurality of quaternary ammonium groups (e.g., poly[(tetraalkyl)ammonium halide])). In some embodiments, X is a halide (e.g., chloride, bromide, iodide. Non-limiting examples of quaternary ammonium compounds include choline halide (e.g., chloride), N,N,N-trimethylethanolammonium halide (e.g., chloride), poly(diallyldimethylammonium chloride), poly[(3-chloro-2-hydroxypropyl)methacryloxyethyldimethyl-ammonium chloride, poly(acrylamide-methacryloxyethyltrimethyl-ammonium bromide 80:20), 21744 Poly(butyl acrylate-methacryloxyethyltrimethyl-ammonium bromide 80:20), poly(1-methyl-2-vinylpyridinium bromide); poly(methyacryloxyethyltriethylammonium bromide). IN some embodiments, the cationic inhibitor and/or stabilizer may be SS+™ or PCS™, available from Flotek. Other non-limiting examples of cationic inhibitor and/or stabilizers include ClaProtek CF (CESI Chemical Inc.), CSM-3 (CESI Chemical Inc.), and CSM-50 (CESI Chemical Inc.).

As will be known to those of ordinary skill in the art, clay is generally found as a component of shale in oil and/or gas well. Shale may also comprise quartz, silica, and/or calcium carbonate. Non-limiting examples of clays include hematite, montmorillinite, illite, and smectite.

The cationic inhibitor and/or cationic stabilizer may be incorporated into a drilling fluid in any suitable amount. In some embodiments, the cationic inhibitor and/or cationic stabilizer is incorporated into the drilling fluid prior to and/or during injection into the wellbore. In some embodiments, a composition is provided comprising a cationic inhibitor and/or cationic stabilizer and the drilling fluid (e.g., drilling mud). In some embodiments, the cationic inhibitor and/or cationic stabilizer is present in a drilling fluid or provided to a drilling fluid in an amount between about 0.0024 and about 0.24 lbs/gallon (e.g., gallon of drilling fluid), or between about 0.024 and about 0.24 lbs/gallon, or between about 0.0024 and about 0.12 lbs/gallon, or between about 0.05 and about 0.2 lbs/gallon, or between about 0.07 and about 014 lbs/gallon, or between about 0.024 and about 0.12 lb/gallon, or between about 0.024 and about 0.07 lbs/gallon. Alternatively, the amount of cationic inhibitor and/or cationic stabilizer may be present in the drilling fluid and/or added to the drilling fluid in an amount defined as pound per barrel (e.g., barrel of drilling fluid) or “ppb”, wherein a barrel is equivalent to about 42 gallons of drilling fluid. In some embodiments, the cationic inhibitor and/or cationic stabilizer may be present in an amount between about 0.1 and about 10 ppb, or between about 0.1 and about 5 ppb, or between about 1 and about 10 ppb, or between about 2 and about 8 ppb, or between 3 and about 6 ppb, or between about 1 and about 5 ppb, or between about 1 and about 3 ppb.

Any suitable method for injecting the composition (e.g., comprising an emulsion or microemulsion and a cationic inhibitor and/or stabilizer) into a wellbore may be employed. For example, in some embodiments, the composition may be injected into a subterranean formation by injecting it into a well or wellbore in the zone of interest of the formation and thereafter pressurizing it into the formation for the selected distance. In some embodiments, the composition (e.g., comprising an emulsion or microemulsion and a cationic inhibitor and/or cationic stabilizer) may be diluted with a drilling fluid. The composition may be added to the drilling fluid prior to, during, and/or following addition of the drilling fluid to the wellbore. The components of the composition may be present in an amount such that the total amount of each component in the drilling fluid (e.g., following dilution of a composition with the drilling fluid) is as described herein. For example, the composition may comprise the emulsion or microemulsion in an amount so that upon dilution with a drilling fluid, the emulsion or microemulsion is present in an amount between amount between 0.001 wt % and 1 wt %, or between about 0.001 wt % and about 0.05 wt %, or between about 0.01 wt % and about 0.1 wt % versus the drilling fluid, and the composition may comprise the cationic inhibitor and/or cationic stabilizer in the amount such that upon dilution with the drilling fluid, the cationic inhibitor and/or cationic is present in an amount between about 0.1 and about 10 ppb, or between about 0.1 and about 5 ppb, or between about 1 and about 10 ppb, or between about 2 and about 8 ppb, or between 3 and about 6 ppb, or between about 1 and about 5 ppb, or between about 1 and about 3 ppb. Methods for achieving the placement of a selected quantity of a mixture in a subterranean formation are known in the art. The well may be treated with the composition for a suitable period of time. The composition and/or other fluids may be removed from the well using known techniques, including producing the well.

In some embodiments, the composition may be employed in an aerated or foamed system. Methods for forming and utilizing an aerated or foamed system will be known to those of ordinary skill in the art. For example, the composition or drilling fluid comprising the composition may further comprise at least one gas (e.g., nitrogen gas, carbon dioxide).

Additional details, advantages, and embodiments of the methods and compositions described herein are described in the following non-limiting examples. The following non-limiting examples are included to demonstrate various features of the invention. Those of ordinary skill in the art should, in light of the present disclosure, will appreciate that many changes can be made in the specific embodiments which are disclosed while still obtaining a like or similar result without departing from the scope of the invention as defined by the appended claims. Accordingly, the following examples are intended only to illustrate certain features of the present invention, but do not necessarily exemplify the full scope of the invention.

These and other aspects of the present invention will be further appreciated upon consideration of the following Examples, which are intended to illustrate certain particular embodiments of the invention but are not intended to limit its scope, as defined by the claims.

### EXAMPLES AND EMBODIMENTS

### First Non-Limiting Example: Shale Drilling

In some embodiments, the compositions provided herein (e.g., comprising an emulsion or a microemulsion and a cationic inhibitor and/or cationic stabilizer) provide benefits as compared to use of a drilling fluid alone. For example, in some embodiments, the drilling fluid comprising the emulsion or the microemulsion and a cationic inhibitor and/or cationic stabilizer provides synergistically enhanced deliverables of optimized borehole stability in shales and relative permeability of hydrocarbons in reservoirs. In some embodiments, the compositions provide the ability to be chemically compatible with the natural chemical environment of shales and/or pro-actively leverage performance off of the associated natural pre-existing capillary pressures (vacuum pressures) therein.

As will be known to those skilled in the art, cationic inhibition generally provides the highest degree of water-based inhibition to reactive clays. For example, a carbonate-bicarbonate alkalinity environment may be preferential to clay and shales and can be a direct result of naturally occurring acid gases typically associated with hydrocarbon generating and bearing environments. In some embodiments, the microemulsions can function as sub-nano multiple phase interfacial tension reducers that may, for example, facilitate the conversion of imbibition into a pro-active tool by providing a unique delivery mechanism for shale stabilization.

In some embodiments, the size of the emulsion or the microemulsion may affect the results obtained when using a composition. For example, in some embodiments, the size of the microemulsion may allow for loading of the product into the 0.001-0.002 mD primary permeability of coals during imbibition.

As will be known to those of ordinary skill in the art, the “vacuum” capillary pressures associated with a primary and secondary permeability environments can vary. These vacuum pressures may result from the capillary diameter and/or the degree of saturation of the shales. In some embodiments, the smaller the diameter of the capillary the higher the capillary pressure (vacuum pressure) and/or the more under saturated the shale and/or the higher the capillary pressure. These pressures are generally independent of reservoir pressure.

As will be known to those of ordinary skill in the art, imbibition is an instantaneous process that occurs when water comes in contact with the exposed primary permeability of water wet shales and/or clays. This exposed primary permeability may be on the face of the drilled cuttings and borehole wall and/or along the faces of the naturally occurring micro-fracturing (secondary permeability). In the case of secondary permeability, the overall depth of invasion into the formation may be directly related to the depth of the micro fracturing and the volume of whole water-based fluid and/or filtrate allowed to feed into the micro-fractures. The speed of invasion of the available water-based fluid or filtrate into the secondary permeability is generally related to the primary permeability features of capillary diameters and degree of saturation of the shales.

In some embodiments, addition of a composition (e.g., comprising an emulsion or microemulsion and a cationic inhibitor and/or cationic stabilizer) to a drilling fluid may function as a multiple phase interfacial tension reducer. Without wishing to be bound by theory, due in part to the small size and chemical features of the microemulsion, the microemulsion can have high surface area efficiency and/or can relieve frictional and/or minimize attractive forces between gases, liquids, semi-solids and/or solids they come in contact with. These features provide the benefit of facilitating enhanced performance of product component of drilling fluids, completion fluids, stimulation fluids, and/or workover fluids while optimizing clean-up of reservoirs and permeability to hydrocarbons.

The compositions comprise features to convert imbibition into a proactive drilling tool in shales, particularly in under saturated shales where extremely high capillary pressures exist, for example, via their ability to increase the immediate rate of imbibition and/or volume of imbibed fluids. In so doing, the compositions facilitate increasing the speed and/or maximizing the delivered load of structural inhibition additives internal to the shales thereby, for example, providing instant deep stabilization to the exposed bore hole. This can aid in maintaining stability of the pre-existing stress cage around the bore hole without aggravating it.

The multiple phase interfacial tension reducing features of the compositions can also optimize water-based fluid components performance and/or their interaction with formations both on the face of exposed formations where filtercakes are formed and internal to producing reservoirs.

Reduction of the interfacial tension between the liquid phase of the drilling fluid and various products incorporated for generation of the filtercake facilitates can ease of movement of the filtercake components through the liquid phase, deposition of the components onto the bore surface of the exposed permeable formation, and/or mitigates undesired bonding of these additive filtercake building components to the exposed formation. A minimally bonding protective filtercake may be deposited to control dynamic fluid loss to the formation. This can translate into reduced lift off pressures of the filtercake from the formation when cleaning up the well to produce it.

By reducing the interfacial tension between solids, semi-solids, liquids, and/or gases, reduced resistance to flow the physical feature of spurt loss can increase. In so doing the penetration volume of fluid filtrate can increase. The increased volume of invading fluid filtrate into the reservoir carries with it a microemulsion. This delivers interfacial tension reduction between the in situ reservoir liquids and gases it comes in contact and/or instant stabilization of any reactive clays associated with the reservoir it comes in contact with. The net result is upon drilling into the high perm reservoir is the invading filtrate resultant from the formation of the filtercake is a reservoir performance enhancing pay load immediately stabilizing reactive clays and/or optimizing relative permeability to hydrocarbons within the reservoir. (e.g., see Ref. 2007 SPE Rocky Mountain Oil and Gas Technology Symposium Paper 107739 PP Optimizing Reservoir Permeability to Hydrocarbons with Microsolution Technologies, herein incorporated by reference)

The vacuum pressure at the opening of the capillary is generally referred to as the end cap pressure. When a composition is imbibed into the capillary, it can drop interfacial tension between phases and the end cap pressure can be reduced accordingly (e.g., 60%). This reduction of end cap pressure can facilitate mitigation of phase trapping and sub-straight accumulation impairment of secondary permeability within reservoirs.

The suite of and a cationic inhibitors described herein are structurally well suited for internal delivery within exposed shales immediately upon being drilled through instantaneous imbibition.

Naturally occurring imbibition can be enhanced with the presence of the correct compositions and therefore the delivery and/or loading of the and a cationic inhibitor and/or cationic stabilizer can be optimized.

In some embodiments, the selection of which and a cationic inhibitor and/or cationic stabilizer to employ is governed by the application. For example when drilling coalbed methane (CBM) wells where shales is generally encountered as the bore path leaves the coal and high carbonate content produced water from field production is employed as the base fluid, the cationic inhibitor and/or cationic stabilizer ClaProtek CF (CESI Chemical Inc.), may be the utilized (e.g., particularly when an aerated or foam system is to be used). The associated bicarbonate ions chemically may enhance foam stability. In addition, CSM-38 and/or CSM-50 (CESI Chemical Inc.) may be useful for shale applications (e.g., as the cationic inhibitor and/or stabilizer).

Generation of unique micelles and deposition thereof upon the surface of the bore hole can vary when the microemulsions and/or shale inhibitors are in the presence of triglyceride oils, sulfonated asphalts, diesels and polymers such as xanthan gums, starches, PAC's, carboxymethyl carbonates (CMCs), and/or guars mitigate water transference from the bulk water-based system to the shales providing synergistic enhancement of stability to the near bore hole. Another feature and benefit of this generated micellular membrane may be a reduction of the coefficient of friction associated with the contact of the drill string with exposed formations or other tubulars such as casing thereby optimizing the well construction process. Accordingly, the use of microemulsions in method of internal shale stabilization via imbibition when coupled with the micellular membrane mitigates water aggravation of shales and therefore contributes to physical stabilization the “stress cage” around the well bore.

### Second Non-Limiting Example: Coalbed Methane (CBM) Cationic Drilling Fluids

In some embodiments, composition for use with CBM cationic water-based fluid are provided. In some cases, the compositions provide synergistically enhanced deliverables optimizing well construction, improved borehole stability when shales are drilled, and/or maximized relative permeability of hydrocarbons. Generally, the composition comprises customizing the fluid design for drilling operations while remaining chemically compatible with the natural chemical environment of coals and exposed shales. For example, targeted performance off of the natural pre-existing capillary pressures (vacuum pressures) associated with the primary permeability of coal may be targeted; particularly highly water sensitive dry coals.

In some embodiments, cationic inhibition can provide a high degree of water-based inhibition to the exposed reactive clays encountered when drilling. For example, carbonate-bicarbonate alkalinity of some system designs may be highly compatible with carbonate-bicarbonate alkalinity of the water typically produced from coals and is preferential to clay and shales. These alkalinities may be the result of naturally occurring acid gases typically associated with hydrocarbon generating and bearing coal environments. Coupling these basic fundamentals and use of an emulsion or a microemulsion, as well as system design (e.g., mist, aerated, foam or non-aerated and weighted) and optimum clay inhibitor, a useful and new class of water-based fluid technology are provided to the CBM industry.

In some embodiments, the microemulsions can function as sub-nano multiple phase interfacial tension reducers that may, for example, facilitate the conversion of imbibition into a pro-active tool to minimize end cap pressures, e.g., for the purpose of mitigating phase trapping; particularly in dry coals.

In some embodiments, the size of the emulsion or the microemulsion may affect the results obtained when using a composition. For example, in some embodiments, the size of the microemulsion can allow for loading of the product into the 0.001-0.002 mD primary permeability of coals during imbibition.

As will be known to those of ordinary skill in the art, “vacuum” capillary pressures associated with the primary and secondary permeability environments can vary. These vacuum pressures may result from the capillary diameter and/or the degree of saturation of the coals. In some embodiments, the smaller the diameter of the capillary, the higher the capillary pressure (vacuum pressure) and/or the more under saturated the coal and/or the higher the capillary pressure. Generally, these pressures are independent of reservoir pressure.

As will be known to those of ordinary skill in the art, imbibition is an instantaneous process that occurs when water comes in contact with the exposed primary permeability of coal. This exposed primary permeability may be on the face of the drilled cuttings and borehole wall and/or along the faces of the naturally occurring micro-fracturing “cleats” (secondary permeability). In the case of secondary permeability, the overall depth of invasion into the coal may be directly related to the depth and severity of the cleating, the volume of invading fluid and/or filtrate allowed to feed into the micro-fractures, and/or the differential between the hydrostatic head pressure and the reservoir pressure. The speed of invasion of the available water-based fluid and/or filtrate into the secondary permeability is generally related to the primary permeability features of capillary diameters and degree of saturation of the coals.

The microemulsions can function as multiple phase interfacial tension reducers. Due in part to their small size and chemical features, the microemulsions can have a high surface area efficiency and/or relieve frictional and/or minimize attractive forces between gases, liquids, semi-solids, and/or solids they come in contact with. These features can provide the benefit of facilitating enhanced performance of additive product components of fluids used to drill, completion, stimulate or workover CBM wells. Their features include the optimization of reservoir clean-up and enhancing permeability to hydrocarbons.

The compositions allow for imbibition into a pro-active drilling tool in coals, particularly in under saturated coals where extremely high capillary pressures exist, and/or ability to mitigate phase trapping of the primary permeability associated with fluid imbibition.

The vacuum pressure at the opening of the capillary is generally referred to as the end cap pressure. When a microemulsion is imbibed into the capillary, it can drop the interfacial tension between phases and/or the end cap pressure is reduced accordingly (e.g., 60%). This reduction of end cap pressure can facilitate mitigation of phase trapping and/or the generation of sub-straight upon which accumulation is possible to drive impairment of secondary permeability within reservoirs (e.g., coal fines, shale fines, unwanted bonding cations or anions, polymers, etc.).

Reduction of the interfacial tension between the liquid phase and the coal fines generated during the drilling process can also minimize the severity of packing off and/or bonding of the fines within the exposed cleats. This can facilitate ease of fines removal and/or expedites “black water” clean-up during well completion or post cavitation operations.

The cationic shale inhibitors described herein are structurally well suited for internal delivery within exposed shales immediately upon being drilled through instantaneous imbibition. Naturally occurring imbibition can be enhanced with the presence of the microemulsions and therefore, the delivery and/or loading of the cationic shale inhibitor may be optimized.

The selection of which cationic inhibitor and/or stabilizer to employ may be governed by the application. For example, when drilling CBM wells where shales will be encountered as the bore path leaves the coal and high carbonate content produced water from field production is employed as the base fluid, ClaProtek CF (CESI Chemical Inc.) may be utilized (e.g., particularly when an aerated or foam system is to be used). The associated bicarbonate ions can chemically enhance foam stability.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A composition for treatment of an oil and/or gas well, comprising:
a cationic inhibitor and/or a cationic stabilizer; and
an emulsion or a microemulsion.

2. A method for treating an oil and/or gas well, comprising:
providing a composition comprising a drilling fluid, a cationic inhibitor and/or a cationic stabilizer, and an emulsion or microemulsion to a wellbore of the oil and/or gas well.

3. The composition of claim 1, wherein the emulsion or microemulsion comprises an aqueous component, an organic component, and one or more surfactants.

4. The composition of claim 3, wherein the organic component comprises a terpene.

5. The composition of claim 3, wherein the organic component is present in an amount between about between about 2 wt % and about 60 wt %, or between about 5 wt % and about 40 wt %, or between about 5 wt % and about 30 wt %, versus the total emulsion or microemulsion composition.

6. The composition of claim 3, wherein the ratio the aqueous component to the organic component is between about 3:1 and about 1:2, or between about 2:1 and about 1:1.5.

7. The composition of claim 3, wherein the surfactant is present in an amount between about 10 wt % and about 70 wt %, or between about 15 wt % and about 55 wt %, or between about 20 wt % and about 50 wt %, versus the total emulsion or microemulsion composition.

8. The composition of claim 3, wherein the emulsion or microemulsion further comprising a freezing point depression agent.

9. The composition of claim 8, wherein the freezing point depression agent is present in an amount between about 1 wt % and about 40 wt %, or between about 3 wt % and about 20 wt %, or between about 8 wt % and about 16 wt %, versus the total emulsion or microemulsion composition.

10. The composition of claim 1, wherein the emulsion or microemulsion is incorporated into a drilling fluid in an amount between 0.001 wt % and 1 wt %, or between about 0.001 wt % and about 0.05 wt %, or between about 0.01 wt % and about 0.1 wt % versus the drilling fluid.

11. The composition of claim 1, wherein the cationic inhibitor and/or cationic stabilizer is present in an amount between about 0.1 and about 10 ppb, or between about 0.1 and about 5 ppb, or between about 1 and about 10 ppb, or between about 2 and about 8 ppb, or between 3 and about 6 ppb, or between about 1 and about 5 ppb, or between about 1 and about 3 ppb versus the drilling fluid.

12. The method of claim 2, wherein the emulsion or microemulsion comprises an aqueous component, an organic component, and one or more surfactants.

13. The method of claim 12, wherein the organic component comprises a terpene.

14. The method of claim 12, wherein the organic component is present in an amount between about between about 2 wt % and about 60 wt %, or between about 5 wt % and about 40 wt %, or between about 5 wt % and about 30 wt %, versus the total emulsion or microemulsion composition.

15. The method of claim 12, wherein the ratio of the aqueous component to the organic component is between about 3:1 and about 1:2, or between about 2:1 and about 1:1.5.

16. The method of claim 12, wherein the surfactant is present in an amount between about 10 wt % and about 70 wt %, or between about 15 wt % and about 55 wt %, or between about 20 wt % and about 50 wt %, versus the total emulsion or microemulsion composition.

17. The method of claim 12, wherein the emulsion or microemulsion further comprising a freezing point depression agent.

18. The method of claim 17, wherein the freezing point depression agent is present in an amount between about 1 wt % and about 40 wt %, or between about 3 wt % and about 20 wt %, or between about 8 wt % and about 16 wt %, versus the total emulsion or microemulsion composition.

19. The method of claim 12, wherein the emulsion or microemulsion is incorporated into a drilling fluid in an amount between 0.001 wt % and 1 wt %, or between about 0.001 wt % and about 0.05 wt %, or between about 0.01 wt % and about 0.1 wt % versus the drilling fluid.

20. The method of claim 12, wherein the cationic inhibitor and/or cationic stabilizer is present in an amount between about 0.1 and about 10 ppb, or between about 0.1 and about 5 ppb, or between about 1 and about 10 ppb, or between about 2 and about 8 ppb, or between 3 and about 6 ppb, or between about 1 and about 5 ppb, or between about 1 and about 3 ppb versus the drilling fluid.
